(19) United States
(12) Patent Application Publication
(10) Pub. No.: US 2025/0278471 A1
(43) Pub. Date: Sep. 4, 2025

(54) AUTHENTICATION APPARATUS, AUTHENTICATION TARGET APPARATUS, IMAGE FORMING APPARATUS, AND REPLACEMENT UNIT FOR THE IMAGE FORMING APPARATUS

(71) Applicant: CANON KABUSHIKI KAISHA, Tokyo (JP)

(72) Inventors: ICHIRO IIJIMA, Kanagawa (JP); HISASHI ENOMOTO, Shizuoka (JP)

(21) Appl. No.: 19/067,579

(22) Filed: Feb. 28, 2025

(30) Foreign Application Priority Data
Mar. 1, 2024 (JP) 2024-031611

(51) Int. Cl. G06F 21/44; G06F 3/12; G06F 21/34; G06F 21/86

(52) U.S. Cl. CPC G06F 21/44; G06F 3/1222; G06F 3/1238; G06F 3/1284; G06F 21/34; G06F 21/86

(57) ABSTRACT

An authentication apparatus that authenticates an authentication target apparatus, includes: an acquisition unit configured to acquire, from the authentication target apparatus, information indicating secret data stored in the authentication target apparatus, a first hash value that corresponds to the secret data, and a repeat count N, wherein N is an integer of 2 or more; an operation unit configured to obtain a second hash value from input data that is based on the secret data, by performing N repeated operations using a one-way function; and an authentication unit configured to authenticate the authentication target apparatus by comparing the first hash value acquired by the acquisition unit from the authentication target apparatus with the second hash value obtained by the operation unit.

### BACKGROUND

### Field of the Disclosure

The present disclosure relates to a technology for authentication of an authentication target apparatus by an authentication apparatus.

### Description of the Related Art

If a component that is not expected in the design is connected to an apparatus, this may cause a failure of the apparatus or an unexpected event. Therefore, it is necessary to determine whether or not the component attached to the apparatus is a genuine product, and to alert the user if the component is determined to be not a genuine product. International Publication No. 2018/080497 discloses a configuration that uses a password, a hash value, and an encryption key to determine whether or not a replacement unit attached to an apparatus is a genuine product. Typically, the larger the data lengths (bit lengths) of the password, hash value, and encryption key are, the higher the resistance to cryptanalysis attacks such as brute-force attacks can be.

However, due to an improvement in processing capacity of computers, the data length required to maintain sufficient resistance to cryptanalysis attacks has increased, and is expected to continue to increase in the future. On the other hand, memory devices that store information for use in authentication may have limited capacity due to the cost and the like. Therefore, the data length of information for use in authentication may not be sufficient to resist cryptanalysis attacks.

### SUMMARY

According to a present disclosure, an authentication apparatus that authenticates an authentication target apparatus, includes: an acquisition unit configured to acquire, from the authentication target apparatus, information indicating secret data stored in the authentication target apparatus, a first hash value that corresponds to the secret data, and a repeat count N, wherein N is an integer of 2 or more; an operation unit configured to obtain a second hash value from input data that is based on the secret data, by performing N repeated operations using a one-way function; and an authentication unit configured to authenticate the authentication target apparatus by comparing the first hash value acquired by the acquisition unit from the authentication target apparatus with the second hash value obtained by the operation unit.

Further features of the present disclosure will become apparent from the following description of exemplary embodiments with reference to the attached drawings.

### BRIEF DESCRIPTION OF THE DRAWINGS

FIG. 1 is a diagram showing a configuration of an image forming apparatus according to one or more aspects of the present disclosure.

FIG. 2 is a diagram showing a configuration of an authentication system according to one or more aspects of the present disclosure.

FIG. 3A is a diagram illustrating a relationship between information of a secret data table and information of a hash value table.

FIG. 3B is a diagram illustrating a relationship between information of the hash value table and information of a combined hash value.

FIG. 4 is a flowchart of authentication processing according to one or more aspects of the present disclosure.

FIG. 5 is a diagram showing a configuration of an authentication system according to one or more aspects of the present disclosure.

FIG. 6 is a flowchart of processing that is executed by an authentication target chip in the authentication processing.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

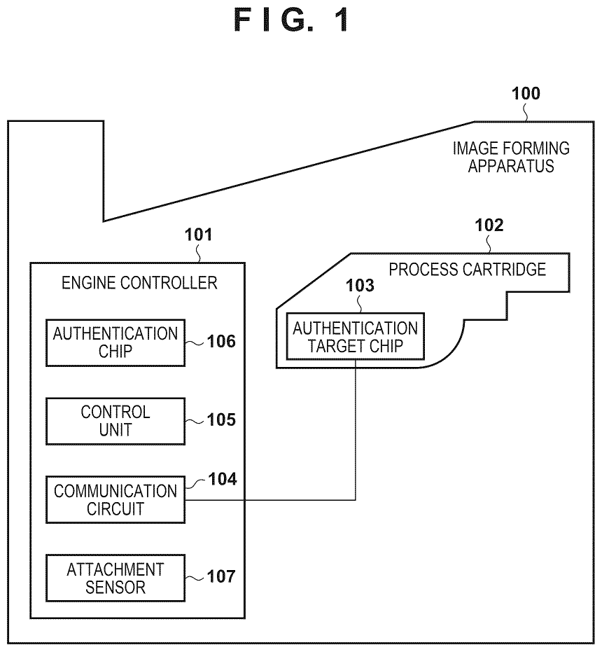

FIG. 1 is a diagram showing an image forming apparatus 100 that constitutes an authentication system according to the present embodiment. The image forming apparatus 100 is, for example, a printer, copier, or multifunctional machine, and forms images on sheets according to an electrophotographic process. A process cartridge 102 is a unit (replacement unit) that can be detached from the body of the image forming apparatus 100. The process cartridge 102 includes, for example, a photoreceptor and members required to form a toner image on the photoreceptor. The process cartridge 102 performs part of processing of forming an image on a sheet under the control of an engine controller 101. The process cartridge 102 includes an authentication target chip 103. The authentication target chip 103 is a tamper-resistant device, and functions as an authentication target apparatus.

The engine controller 101 provided in the main body of the image forming apparatus 100 includes a control unit 105, an authentication chip 106, a communication circuit 104, and an attachment sensor 107, and functions as an authentication apparatus that authenticates the authentication target apparatus. The control unit 105 serves also as a controller that comprehensively controls the entire image forming apparatus 100. The authentication chip 106 performs processing of authenticating the authentication target chip 103. The authentication chip 106 may be a tamper-resistant device. The communication circuit 104 performs communication processing with the process cartridge 102. The attachment sensor 107 detects the attachment of the process cartridge 102 to the main body of the image forming apparatus 100. When the attachment sensor 107 detects the attachment of the process cartridge 102, the control unit 105 starts authentication processing, which will be described later.

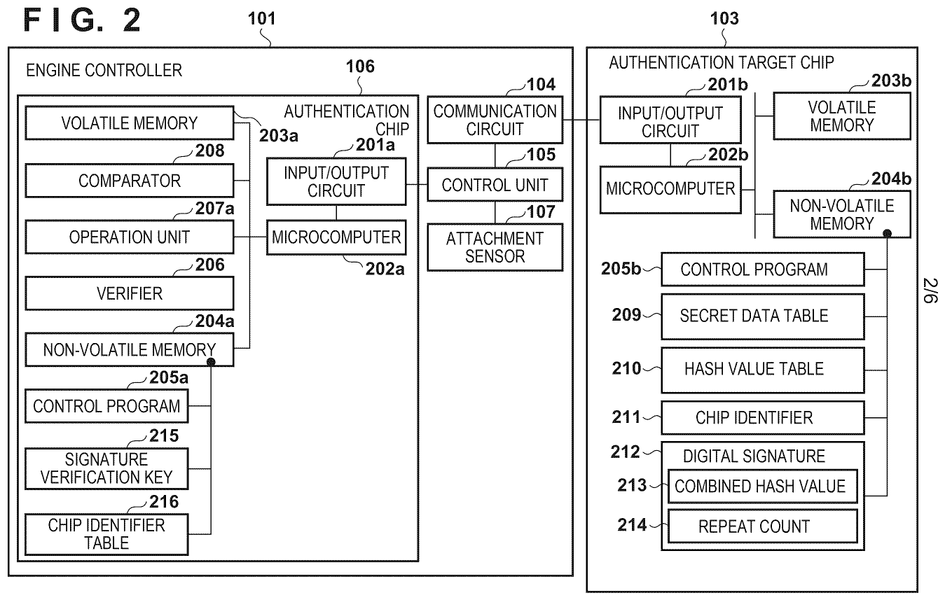

FIG. 2 is a diagram showing a configuration of the authentication system including the authentication chip 106 and the authentication target chip 103. An input/output circuit 201a of the authentication chip 106 relays data that is transmitted and received between the control unit 105 and a microcomputer 202a. The microcomputer 202a executes necessary processing in accordance with commands from the control unit 105. At this time, the microcomputer 202a stores data necessary for the processing in a volatile memory 203a. A non-volatile memory 204a stores a control program 205a for the authentication chip 106, a signature verification key 215, and a chip identifier table 216. The chip identifier table 216 stores identifiers (chip identifiers) of authentication target chips 103 that were successfully authenticated in the past. A verifier 206 verifies a digital signature based on the signature verification key 215. An operation unit 207a uses a one-way function F to obtain hash values of input data. A comparator 208 determines whether or not two pieces of input data match each other. Note that a configuration is also possible in which the microcomputer 202a performs the processing performed by one or more of the verifier 206, the operation unit 207a, and the comparator 208.

The image forming apparatus 100 is configured so that, when the process cartridge 102 is attached to the main body of the image forming apparatus 100, an input/output circuit 201b of the authentication target chip 103 and the communication circuit 104 of the engine controller 101 are electrically connected to each other. The input/output circuit 201b relays data that is transmitted and received between the control unit 105 and a microcomputer 202b. The microcomputer 202b performs necessary processing in accordance with commands from the control unit 105. At this time, the microcomputer 202b stores data necessary for the processing in a volatile memory 203b. A non-volatile memory 204b stores a control program 205b for the authentication target chip 103, a secret data table 209, a hash value table 210, a chip identifier 211, a combined hash value 213, a repeat count 214, and a digital signature 212.

The chip identifier 211 is an identifier assigned to each individual authentication target chip 103, and differs between individual authentication target chips 103. The secret data table 209 is information (table) indicating a plurality of pieces of secret data for use in authentication. The hash value table 210 is information (table) indicating hash values respectively calculated based on the plurality of pieces of secret data indicated in the secret data table 209. The method for calculating a hash value in the hash value table 210 based on secret data indicated in the secret data table 209 will be described later. The digital signature 212 is a digital signature (signature information) generated using a signature key based on information indicating the combined hash value 213 and the repeat count 214. The method of generating the combined hash value 213 will be described later. Note that the signature key used to generate the digital signature 212 corresponds to the signature verification key 215 stored in the authentication chip 106. In other words, by verifying the digital signature 212 using the signature verification key 215, it is possible to verify the validity of the combined hash value 213 and the value of the repeat count 214.

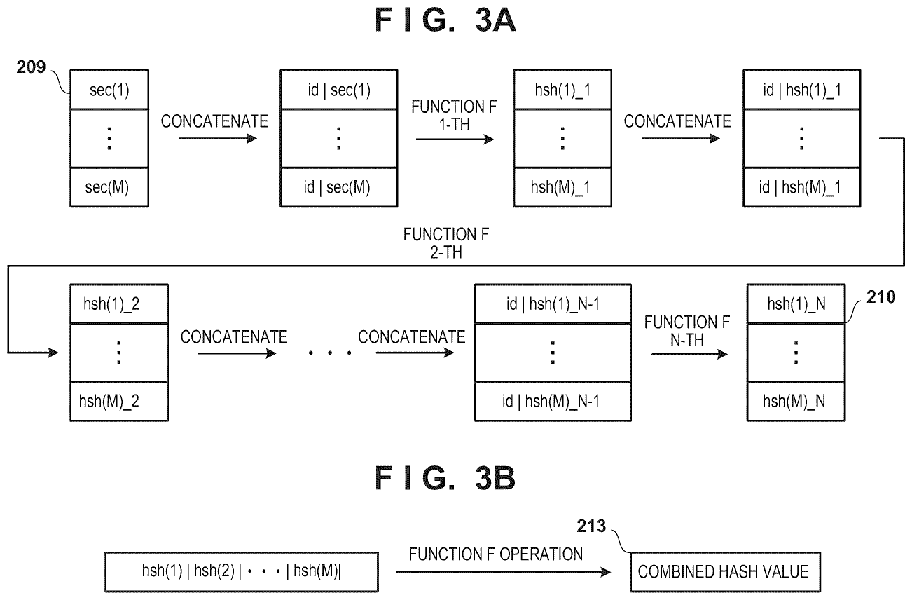

FIG. 3A is a diagram illustrating the relationship between a plurality of pieces of secret data indicated in the secret data table 209 and a plurality of pieces of hash values indicated in the hash value table 210. First, M (M is an integer greater than or equal to 2) pieces of secret data sec(1) to sec(M) are generated in a suitable manner, for example, a random manner. The information indicating the M pieces of secret data sec(1) to sec(M) is stored in the non-volatile memory 204b of the authentication target chip 103 as the secret data table 209.

Then, each of the pieces of secret data sec(1) to sec(M) is concatenated with the corresponding chip identifier 211 stored in the non-volatile memory 204b of the authentication target chip 103 to generate concatenated data. In FIG. 3A, the chip identifier 211 is denoted as “id”. Also, in the following description, “A|B” indicates concatenated data in which data A and data B are concatenated with each other. The concatenated data is then used as an input to the one-way function F to generate a hash value. In FIG. 3A, hsh(m)_1 (m is an integer from 1 to M) indicates a hash value obtained by using concatenated data “id|sec(m)” as an input to the one-way function F. Note that “n” in the notation “hsh(m)_n” indicates the number of times the output of the one-way function F is obtained.

Then, “hsh(m)_1” is concatenated with the chip identifier 211 to generate concatenated data. In FIG. 3A, “id|hsh(m)_1” indicates concatenated data in which hsh(m)_1 and id are concatenated with each other. Then, the concatenated data is used as an input to the one-way function F to generate a second hash value. In FIG. 3A, hsh(m)_2 indicates a hash value obtained by using “id|hsh(m)_1” as an input to the one-way function F. In this way, by N repeated operations of obtaining the hash value using concatenated data with the chip identifier 211 as an input to the one-way function F, the hash values hsh(1) N to hsh(M) N are obtained based on the respective pieces of secret data sec(1) to sec(M). The information indicating the hash values hsh(1) N to hsh(M) N is stored in the non-volatile memory 204b of the authentication target chip 103 as the hash value table 210. Note that in the following description, the M hash values hsh(1) N to hsh(M)_N indicated in the hash value table 210 are simply denoted as hash values hsh(1) to hsh(M).

Note that the information indicating the repeat count N is stored in the non-volatile memory 204b of the authentication target chip 103 as the repeat count 214 and is used to calculate the digital signature 212. Note that the one-way function F used to obtain the hash value hsh(m) from the secret data sec(m) is the same as the one-way function F used by the operation unit 207a of the authentication chip 106.

FIG. 3B is a diagram illustrating the relationship between a plurality of hash values indicated in the hash value table 210 and the combined hash value 213. As shown in FIG. 3B, the combined hash value 213 is obtained by using data in which the M hash values hsh(1) to hsh(M) indicated in the hash value table 210 are concatenated with each other as an input to the one-way function F. Note that this one-way function F is also the same as that used by the operation unit 207a of the authentication chip 106. The combined hash value 213 is stored in the non-volatile memory 204b of the authentication target chip 103 and is used to calculate the digital signature 212.

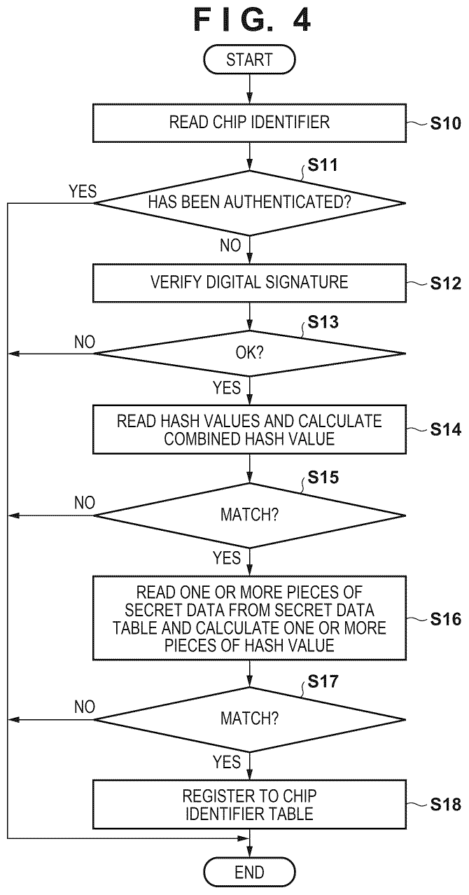

FIG. 4 is a flowchart of authentication processing executed by the control unit 105. The control unit 105 starts the authentication processing shown in FIG. 4 in response to the attachment sensor 107 detecting the attachment of the process cartridge 102. In step S10, the control unit 105 reads the chip identifier 211 of the authentication target chip 103. In step S11, the control unit 105 determines whether or not the read chip identifier 211 is stored in the chip identifier table 216. If the chip identifier 211 is stored in the chip identifier table 216, the control unit 105 determines that the attached process cartridge 102 has been authenticated. In this case, the control unit 105 determines that the authentication is successful and ends the processing in FIG. 4.

On the other hand, if the read chip identifier 211 is not stored in the chip identifier table 216, the control unit 105 reads, in step S12, the digital signature 212, the combined hash value 213, and the repeat count 214, and causes the verifier 206 to verify the digital signature 212. In step S13, the control unit 105 obtains the verification result from the verifier 206. If the verification result indicates an unsuccessful verification (NG), the control unit 105 determines that the authentication is unsuccessful and ends the processing in FIG. 4. On the other hand, when the verification result indicating successful verification (OK) is obtained from the verifier 206, the control unit 105 reads, in step S14, the hash values hsh(1) to hsh(M) in the hash value table 210, and causes the operation unit 207a to calculate the combined hash value. In step S15, the control unit 105 causes the comparator 208 to determine whether or not the combined hash value calculated by the operation unit 207a matches the combined hash value 213 read from the authentication target chip 103.

If the control unit 105 receives a comparison result indicating that the two combined hash values do not match from the comparator 208 in S15, the control unit 105 determines that the authentication is unsuccessful and ends the processing in FIG. 4. On the other hand, if the control unit 105 receives a comparison result indicating that the two combined hash values match each other from the comparator 208 in step S15, the control unit 105 reads one or more pieces of secret data from the secret data table 209 in S16. In the following description, it is assumed that the control unit 105 reads one piece of secret data sec(m). The control unit 105 causes the operation unit 207a to calculate the hash value hsh(m) based on the repeat count 214, the chip identifier 211, and the secret data sec(m).

The operation unit 207a obtains the first piece of output data by using input data that is concatenated data of the secret data (m) and the chip identifier 211 as an input to the one-way function F. Then, the operation unit 207a obtains the hash value hsh(m), by performing operations of obtaining the (k+1)-th output data using concatenated data of the k-th output data and the chip identifier 211 as an input to the one-way function F, in a repeated manner from k=1 to N−1. Note that the value of N is indicated by the repeat count 214.

In step S17, the control unit 105 causes the comparator 208 to determine whether or not the hash value hsh(m) calculated by the operation unit 207a matches the hash value hsh(m) read from the authentication target chip 103.

If the control unit 105 receives a comparison result indicating that the two hash values hsh(m) do not match each other from the comparator 208 in step S17, the control unit 105 determines that the authentication is unsuccessful and ends the processing in FIG. 4. On the other hand, if the control unit 105 receives a comparison result indicating that the two hash values hsh(m) match each other from the comparator 208 in step S17, the control unit 105 determines that the authentication is successful. In this case, the control unit 105 stores the chip identifier 211 read in step S10 in the chip identifier table 216.

Note that in step S16, when a plurality of pieces of secret data, for example, K pieces of secret data (K is an integer from 2 to M), are read, the control unit 105 calculates K hash values corresponding to the K pieces of secret data. If all of the calculated K hash values match the corresponding hash values stored in the hash value table 210, the control unit 105 determines that the authentication is successful. Otherwise, the control unit 105 determines that the authentication is unsuccessful.

If it is determined that the authentication is unsuccessful, the control unit 105 performs, for example, processing of notifying the user that the process cartridge 102 is not a genuine product.

By repeating the above-described calculation using the one-way function F multiple times, it is possible to increase the calculation time in the authentication processing without expanding the data length of the secret data sec(m). This also increases the calculation time required for cryptanalysis attacks such as brute-force attacks, thus improving the resistance to cryptanalysis attacks while reducing an increase in the data length of secret data.

Note that, in the present embodiment, the concatenated data with the chip identifier 211 is always used as input data to the one-way function F when calculating the hash value from the secret data. However, it is sufficient to use the concatenated data with the chip identifier 211 in at least one of the N calculations using the one-way function F, and it is not necessary to always use the concatenated data with the chip identifier 211 as an input to the one-way function F. For example, in the first calculation using the one-way function F, the concatenated data of the secret data and the chip identifier 211 can be used, and in the second to N-th calculations, the output data of each previous one-way function F can be directly used as an input to the one-way function F. Alternatively, a configuration is also possible in which in the first calculation, the hash value is obtained by using only the secret data as an input to the one-way function F, and in the second to the (N−1)-th calculations, the output data of each previous one-way function F is used as an input, and in the N-th calculation, the concatenated data of the hash value output in the (N−1)-th calculation and the chip identifier 211 is used as an input to the one-way function F. Furthermore, the concatenated data may be used in the odd-numbered operations, and the output data of each previous one-way function F may be used as an input to the one-way function F in the even-numbered operations. Furthermore, the concatenated data can be used in the even-numbered operations, and the output data of each previous one-way function F can be used as an input to the one-way function F in the odd-numbered operations.

In the present embodiment, the combined hash value 213 and the repeat count 214 serving as plain text, and the digital signature 212 thereof are stored in the non-volatile memory 204b of the authentication target chip 103. However, a configuration is also possible in which a digital signature of a message recovery type can be stored as the digital signature 212. In this case, in step S12, the verifier 206 verifies the digital signature 212 and restores the combined hash value 213 and the repeat count 214 from the digital signature 212.

### Second Embodiment

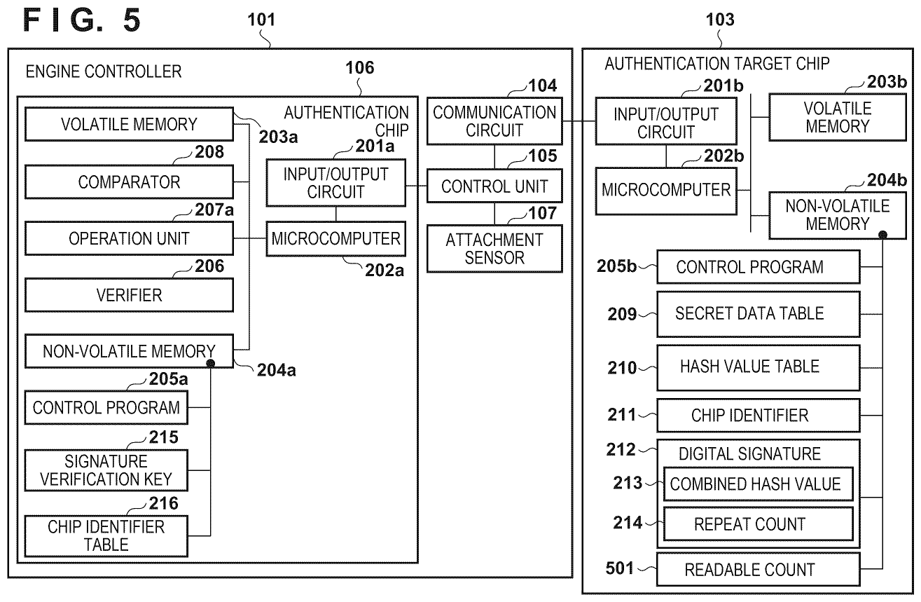

Next, a second embodiment will be described focusing on the differences from the first embodiment. FIG. 5 is a diagram showing a configuration of an authentication system according to the present embodiment. Compared to the authentication system of the first embodiment shown in FIG. 2, the second embodiment differs from the first embodiment in that the non-volatile memory 204b of the authentication target chip 103 stores a readable count 501. At the time of factory shipment, the non-volatile memory 204b of the authentication target chip 103 stores an initial value of the readable count 501. The initial value is information indicating an integer greater than 0, and defines the upper limit of the number of times secret data can be read by the control unit 105.

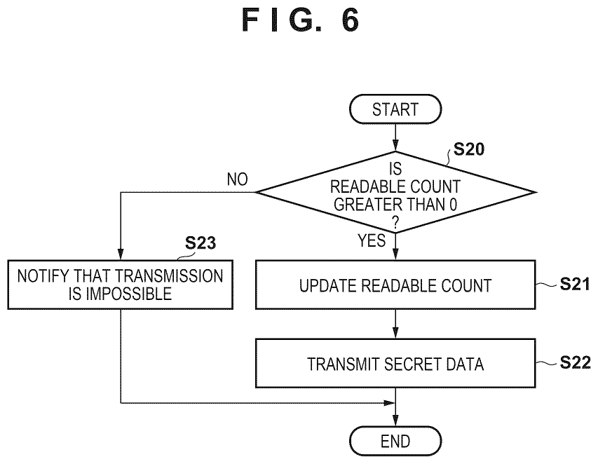

FIG. 6 is a flowchart of processing executed by the microcomputer 202b of the authentication target chip 103 according to the present embodiment. The processing shown in FIG. 6 is executed in response to the control unit 105 of the authentication chip 106 instructing the microcomputer 202b to read secret data. In other words, the processing shown in FIG. 6 is executed in step S16 in FIG. 4 by the authentication target chip 103.

Upon receiving the instruction to read the secret data from the control unit 105, the microcomputer 202b determines in step S20 whether or not the value of the readable count 501 is greater than 0. If the value of the readable count 501 is greater than 0, the microcomputer 202b performs update such that the value of the readable count 501 is decremented by 1 in step S21. The microcomputer 202b then transmits, in step S22, the secret data to be read out in accordance with the instruction, to the control unit 105. On the other hand, if the value of the readable count 501 is not greater than 0 in step S20, the microcomputer 202b notifies, in step S23, the control unit 105 that the secret data is not to be transmitted. Upon being notified by the microcomputer 202b of the fact that the secret data is not to be transmitted, the control unit 105 determines that the authentication is unsuccessful and ends the processing in FIG. 4.

Note that in the present embodiment, even if a plurality of pieces of secret data are to be read out in accordance with the instruction from the control unit 105, the value of the readable count 501 is updated so as to be decremented by 1 in step S21. However, a configuration is also possible in which, in step S21, the value of the readable count 501 is decremented by the number of pieces of secret data to be read out in accordance with the instruction from the control unit 105. In this case, the determination in step S20 is to determine whether or not the value of the readable count 501 is not less than the number of pieces of secret data to be read out in accordance with the instruction from the control unit 105.

Also in the present embodiment, if the value of the readable count 501 is not greater than 0, the microcomputer 202b notifies, in step S23, the control unit 105 that the secret data is not to be transmitted. However, a configuration is also possible in which if the value of the readable count 501 is not greater than 0, the microcomputer 202b does not give any notification to the control unit 105. In this case, if the microcomputer 202b does not transmit secret data even after a predetermined period of time has elapsed since the reception of the instruction to read the secret data, the control unit 105 determines that the authentication is unsuccessful.

According to the present embodiment, as described above, the number of times secret data can be read out is limited. This makes simple data copying difficult and improves security against cryptanalysis attacks.

### Other Configurations

Although the present disclosure has been described with reference to embodiments in which the authentication apparatus is provided in the main body of the image forming apparatus and the authentication target apparatus is provided in the replacement unit of the image forming apparatus, the present disclosure is applicable even to an apparatus different from such an image forming apparatus. In other words, the present disclosure is applicable to any apparatus that uses a replacement unit configured to be detachable from the main body of the apparatus. Note here that the authentication apparatus is attached to the main body of the apparatus, and the authentication target apparatus is attached to the replacement unit of the apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-031611, filed Mar. 1, 2024, which is hereby incorporated by reference herein in its entirety.

What is claimed is:

1. An authentication apparatus that authenticates an authentication target apparatus, comprising:
an acquisition unit configured to acquire, from the authentication target apparatus, information indicating secret data stored in the authentication target apparatus, a first hash value that corresponds to the secret data, and a repeat count N, wherein N is an integer of 2 or more;
an operation unit configured to obtain a second hash value from input data that is based on the secret data, by performing N repeated operations using a one-way function; and
an authentication unit configured to authenticate the authentication target apparatus by comparing the first hash value acquired by the acquisition unit from the authentication target apparatus with the second hash value obtained by the operation unit.

2. The authentication apparatus according to claim 1, wherein the authentication unit determines that authentication of the authentication target apparatus is unsuccessful if the first hash value does not match the second hash value.

3. The authentication apparatus according to claim 1, wherein the acquisition unit is further configured to acquire, from the authentication target apparatus, signature information for verifying the information indicating the repeat count, and
the authentication unit determines that authentication of the authentication target apparatus is unsuccessful if verification using the signature information is unsuccessful.

4. The authentication apparatus according to claim 3, wherein the authentication target apparatus stores a plurality of pieces of secret data and a plurality of first hash values that correspond to the plurality of pieces of secret data, and
the signature information is information for verifying the information indicating the repeat count, and information indicating a third hash value that is obtained, using the one-way function, based on a value in which the plurality of first hash values are concatenated with each other.

5. The authentication apparatus according to claim 4, wherein the acquisition unit is further configured to acquire the plurality of first hash values and the third hash value from the authentication target apparatus,
the operation unit is configured to obtain a fourth hash value, using the one-way function, based on a value in which the plurality of first hash values are concatenated with each other, and
the authentication unit determines that authentication of the authentication target apparatus is unsuccessful if the third hash value acquired by the acquisition unit from the authentication target apparatus does not match the fourth hash value obtained by the operation unit.

6. The authentication apparatus according to claim 1, wherein the acquisition unit is further configured to acquire an identifier of the authentication target apparatus from the authentication target apparatus, and
the input data is concatenated data of the secret data and data indicating the identifier.

7. The authentication apparatus according to claim 6, wherein the operation unit is configured to obtain the second hash value, by obtaining first output data using the input data as an input to the one-way function, and obtaining (k+1)-th output data using concatenated data of k-th output data and the data indicating the identifier as an input to the one-way function in a repeated manner from k=1 to N−1.

8. An image forming apparatus that comprises an authentication apparatus, and from which a unit is detachable, the unit including an authentication target apparatus to be authenticated by the authentication apparatus, wherein
the authentication apparatus includes:
an acquisition unit configured to acquire, from the authentication target apparatus, information indicating secret data stored in the authentication target apparatus, a first hash value that corresponds to the secret data, and a repeat count N, wherein N is an integer of 2 or more;
an operation unit configured to obtain a second hash value from input data that is based on the secret data, by performing N repeated operations using a one-way function; and
an authentication unit configured to authenticate the authentication target apparatus by comparing the first hash value acquired by the acquisition unit from the authentication target apparatus with the second hash value obtained by the operation unit.

9. An authentication target apparatus that is to be authenticated by an authentication apparatus, comprising:
a storage unit configured to store information indicating a plurality of pieces of secret data, first hash values that respectively correspond to the plurality of pieces of secret data, and a repeat count N, wherein N is an integer of 2 or more; and
a processing unit configured to perform processing of transmitting the information stored in the storage unit to the authentication apparatus in accordance with an instruction from the authentication apparatus,
wherein a first hash value corresponding to secret data of the plurality of pieces of secret data is obtained from input data that is based on the secret data, by N repeated operations using a one-way function.

10. The authentication target apparatus according to claim 9, wherein the storage unit further stores signature information for verifying the information indicating the repeat count.

11. The authentication target apparatus according to claim 10, wherein the signature information is information for verifying the information indicating the repeat count, and information indicating a third hash value that is obtained, using the one-way function, based on a value in which the plurality of first hash values respectively corresponding to the plurality of pieces of secret data are concatenated with each other.

12. The authentication target apparatus according to claim 9, wherein the input data is concatenated data of the secret data and data indicating an identifier of the authentication target apparatus.

13. The authentication target apparatus according to claim 12, wherein the first hash value corresponding to the secret data is obtained, by obtaining first output data using the input data as an input to the one-way function, and obtaining (k+1)-th output data using concatenated data of k-th output data and the data indicating the identifier as an input to the one-way function in a repeated manner from k=1 to N−1.

14. The authentication target apparatus according to claim 9, wherein, if a number of times of reading the plurality of pieces of secret data by the authentication apparatus reaches an upper limit, the processing unit is further configured not to respond to an instruction to read out secret data from the authentication apparatus or to notify the authentication apparatus that the secret data is not to be transmitted.

15. A replacement unit for an image forming apparatus, comprising
an authentication target apparatus that is to be authenticated by an authentication apparatus of the image forming apparatus,
wherein the authentication target apparatus includes:
a storage unit configured to store information indicating a plurality of pieces of secret data, first hash values that respectively correspond to the plurality of pieces of secret data, and a repeat count N, wherein N is an integer of 2 or more; and
a processing unit configured to perform processing of transmitting the information stored in the storage unit to the authentication apparatus in accordance with an instruction from the authentication apparatus, and
the a first hash value corresponding to secret data of the plurality of pieces of secret data is obtained from input data that is based on the secret data, by N repeated operations using a one-way function.
